(19) United States
(12) Patent Application Publication
(10) Pub. No.: US 2015/0027960 A1
(43) Pub. Date: Jan. 29, 2015

(54) APPARATUS AND METHODS FOR SEQUENTIAL TREATMENTS OF PROCESS FLOWS

(71) Applicants: KC Darrin Troy Hosler, Nanaimo (CA); Douglas Wayne Gorrie, Nanaimo (CA); Roger Coleman, Ladysmith (CA)

(72) Inventors: KC Darrin Troy Hosler, Nanaimo (CA); Douglas Wayne Gorrie, Nanaimo (CA); Roger Coleman, Ladysmith (CA)

(73) Assignee: PR AQUA SUPPLIES LTD., Nanaimo, BC (CA)

(21) Appl. No.: 14/239,969

(22) PCT Filed: Aug. 23, 2012
(86) PCT No.: PCT/IB2012/002184

§ 371 Date: Oct. 13, 2014

Related U.S. Application Data
(60) Provisional application No. 61/526,605, filed on Aug. 23, 2011.

(51) Int. Cl. C02F 9/00; C02F 1/32

(52) U.S. Cl. CPC C02F 9/00; C02F 1/325; C02F 2201/3228; C02F 2201/322; C02F 2301/08
USPC 210/748.11; 210/251; 210/106

(57) ABSTRACT

A purification apparatus comprising a filtration unit comprising filtration screens, a disinfection unit comprising a source of disinfecting light and a passage for filtrate from the filtration unit to the disinfection unit. The filtration unit may be selected from at least one static drum, at least one rotating drum, and at least one filter pack. Louver vanes or baffles may be used in the passage to create turbulence and direct flow. A process for removing particulate matter and disinfecting a process flow comprises the steps of filtering the process flow to remove particulate matter, directing the filtrate to a source of disinfection light while creating turbulence in the filtrate and disinfecting the filtrate.

### RELATED APPLICATIONS

This application claims the benefit of priority of U.S. Provisional Application Ser. No. 61/526,605 filed Aug. 23, 2011, which is incorporated into this application by reference in its entirety.

### FIELD

The field of the inventions is the sequential treatment of process or effluent flows. This field includes but is not limited to the filtration and disinfection of process flows, including waste water flows.

### BACKGROUND

Most processes create waste in one form or another. This waste can be stored, discarded or processed further to create a material with its own uses, including recycle back to the original process. One example can be found in the field of metalworking. Mixtures of soluble oils and water are widely used to cool the cutting tool and its environs. As it is used, this cutting fluid becomes loaded with metallic particulates and decomposed by microbes. The useful life of the cutting fluid can be extended by removing the metallic particulates and treating the contaminated fluid with chemical disinfectants.

Fish tanks and swimming pools present another example. Here the particulates are predominantly organic in character. They are fertile sites for the growth of microbes. Contaminated water typically is treated by recycle means. It is pumped from the tank or pool, passed through a filter and returned to the tank or pool. Chemicals are used to control free-floating microbes and infestations in particles that are not large enough to be caught in the filter.

### SUMMARY

The inventions of the application include an apparatus for removing and disinfecting particulate matter from a process flow comprising a filtration unit comprising at least one filtration screen, a disinfectant unit comprising a source of disinfecting light, and a passage for filtrate from the filtration unit to the disinfectant unit. The filtration unit may comprise at least one static drum with one or more filtration screens on its periphery. The filtration unit also may comprise at least one rotating drum with one or more filtration screens on its periphery. The filtration unit further may comprise at least one filter pack comprising a first filter screen and at least one other filter screen that is different in mesh from the first filter screen

The passage for filtrate of the apparatus may be fitted with a louver, and one or more vanes of the louver may be aimed at the source of disinfecting light. The louver also may create turbulence. The passage for filtrate of the apparatus also may be fitted with at least one baffle, and each baffle may block flow around the source of disinfecting light. The baffle also may create turbulence.

The disinfecting light of the apparatus may be ultraviolet light. The source of disinfecting light may be one or more elongated bulbs and the axis of each bulb may be horizontal. The source of disinfecting light may be a multiplicity of elongated bulbs arranged in a horizontal array, and that array may create turbulence. The surfaces of the apparatus adjacent to the array may be made reflective.

The filtration unit of the apparatus may comprise a level detector that is triggered when the screens of the filtration unit become loaded with particulates. The filtration unit further may comprise a spray bar that washes particulates from the screens.

The inventions of the application further include an apparatus for removing and disinfecting particulate matter from a process flow including a first filtration unit comprising filtration screens, a first disinfectant unit comprising a source of disinfecting light, a first passage for filtrate from the first filtration unit to the first disinfectant unit, a second filtration unit comprising filtration screens, a second disinfectant unit comprising a source of disinfecting light, a second passage for filtrate from the second filtration unit to the second disinfectant unit, and a central outlet box joining the first disinfectant unit with the second disinfectant unit.

The inventions of the application further include a process for removing and disinfecting particulate matter from a process flow comprising the steps of filtering the process flow to remove a majority of the particulate matter, directing the filtrate to a source of disinfecting light while creating turbulence in the filtrate; and disinfecting the filtrate.

### DRAWINGS

FIG. 1 depicts an exploded view of an apparatus for filtering and disinfecting waste water.

FIG. 2 depicts an unexploded view of the apparatus of FIG. 1.

FIG. 3 depicts a side view of the apparatus of FIG. 1.

FIG. 4 depicts a top view of the apparatus of FIG. 1.

FIG. 5 depicts a rear view of the apparatus of FIG. 1.

FIG. 6 depicts a cross-sectional view of the apparatus of FIG. 1.

FIG. 7 depicts an exploded view of another apparatus for filtering and disinfecting waste water.

### DETAILED DESCRIPTION

The discussion that follows relates to certain preferred embodiments of the inventions of this application. The inventions are broader than these preferred embodiments. The full scope of certain of the inventions is defined by the claims at the end of this application.

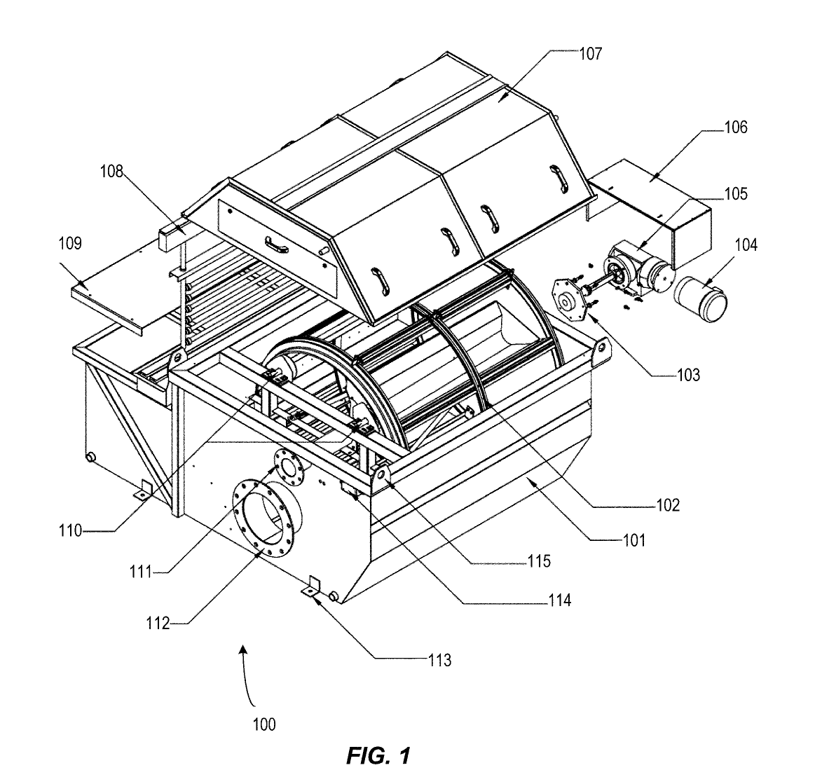

FIG. 1 depicts an exploded view of a preferred embodiment 100 used to treat waste water contaminated with particles and microbes. Following is a list and description of operating components of this unit:

TABLE 1

| Item | Component | Description |
|---|---|---|
| 101 | Filter enclosure | Stainless steel construction |
| 102 | Drum assembly | Drum frame and associated parts. Screen |
| | | panels not shown for clarity. |
| 103 | Drive shaft | Main component of drive system. |
| 104 | Motor | Electric motor for drive system. |
| 105 | Gear | Reduction gear for drive system. |
| 106 | Motor cover | Cover for protecting drive system from the |
| | assembly | elements and to cover exposed moving |
| | | parts. |
| 107 | Lid assembly | Aluminum construction, with removable lid |
| | | panels, access door and spray bar |
| | | assembly |
| 108 | UV module | UV module, complete with bulbs and quartz |
| | | sleeves. |
| 109 | Weir/UV chamber | Aluminum checker plate construction. |
| | lid | Cover for blocking UV light and can be |
| | | used as a platform for UV module |
| | | installation/removal |
| 110 | Support wheel | Drum support wheels with finger guards. |
| | assemblies | |
| 111 | Solids outlet | 4″ flanged outlet from sludge tray. |
| 112 | Inlet | 12″ flanged inlet for influent water. |
| 113 | Location tabs | For securing filter to mounting surface. |
| 114 | Junction box | Water tight connection point filter float |
| | | switches. |
| 115 | Lifting lugs | Lifting points for filter installation. Use |
| | | spreader bar if necessary when lifting. |

Untreated waste water—particulate bearing and microbe infested—is gravity or pump fed through inlet 112 to the inside of drum assembly 102, which has panels of fine screen mounted on its periphery. Drum assembly 102 is rotated periodically for the purpose of cleaning, as will be discussed. Drum assembly 102 also can be rotated can be rotated continuously with periodic cleaning. The end of drum assembly 102 farthest from inlet 112 is sealed with a solid plate, which is either stainless steel or fiberglass. If the plate is stainless steel, it is stitch welded on both sides to the inside of drum assembly 102, then sealed inside and out with a marine urethane sealant. If the plate is fiberglass, it is press fit to the inside of drum assembly 102 and sealed inside and out with a marine urethane sealant. The end of drum assembly 102 nearest to inlet 112 is sealed to the inlet structure using an ethylene-propylene-diene-monomer rubber seal, which is attached to the inlet structure.

Waste water entering drum assembly 102 from inlet 112 flows through the screen panels of drum assembly 102. Particulate and microbial impurities are captured by the screen panels and filtrate exits the screen panels. As this process continues, the screen panels gradually become clogged with accumulated particulates and microbes, and the water level inside drum assembly 102 rises. When the water level reaches a predetermined fill level, a backwash system is activated by a level switch. Drum assembly 102 begins rotating (if not already rotating) and water is sprayed from a spray bar located outside of drum assembly 102. The spray dislodges the particulates and microbes, which are collected in a trough located inside the drum and opposite the spray bar. The clean screen panels are rotated into the water from inlet 112, rotation of drum assembly 102 stops and flow is improved, lowering the water level inside drum assembly 102. The backwash system automatically shuts down to save power. The collected particulates and microbes exit the system through solids outlet 111 for disposal or recovery.

The inventions of the application include filtration apparatus other than or in addition to a drum assembly 102 with filter panels at its periphery. Two drum assemblies may be used in series or in parallel. The series arrangement would be particularly useful when height of the filtration enclosure 101 requires reduction, or where there is a need for more filtration capacity in terms of flow rate or for more filtration capability in terms of particle size. Static filters may also be used. A static filter comprises a filter pack assembled from successively finer mesh filter elements, with the waste water entering at the end of the filter with the largest mesh filter element. Once clogged with particulates and microbes, this filter pack could be cleaned by introducing a stream of clean water at the end of the filter pack with the smallest mesh element. The filter would have to be taken offline during this operation, and it might prove useful to use two or more filter packs in parallel, so that one filter pack is performing filtration while the other filter pack is being cleaned.

Filtrate from the drum assembly 102 passes through a louvered baffle and flows through one or more ultraviolet light modules 108, which are designed to inactivate microbes by exposing the microbes to ultraviolet light, which affects the DNA of the microbes and renders them unable to reproduce. The design dose of ultraviolet light is a function of the particular microbe of concern within the facility, the ultraviolet-light transmittance of the filtrate and the peak flow rate passing through drum 102.

In a preferred format, the ultraviolet light modules comprise a multiplicity of elongated ultraviolet bulbs. These are arranged in a horizontal array, with the axes of the bulbs perpendicular to the direction of motion of the filtrate from drum assembly 102 so as to maximize turbulence of the microbe-bearing water and thus maximizing exposure of the microbes to ultraviolet light and maximizing the efficiency of the system at producing water that is entirely or almost entirely. Turbulence also may be produced by placing turbulence-creating elements in the transition passage of the apparatus between the filtration apparatus and the ultraviolet light modules 108, including asymmetric wall arrangements and rigid members that extent into the transition passage, symmetric or asymmetric. Finally, the effect of the ultraviolet light may be enhanced by using reflective materials for the structure surrounding the ultraviolet light modules 108, such as stainless steel, or coating that structure with a reflective material or coating.

Alternatively, the elongated bulbs may be oriented along a non-horizontal axis, including a vertical axis. In another alternative, the flow can be directed along the axis of the ultraviolet bulbs, whether horizontal or otherwise, rather than perpendicular to that axis. Beyond this, non-elongated bulbs may be used, an example being a medium-powered ultraviolet bulb that fits into a single socket and a resembles a common incandescent bulb in profile.

The FIG. 1 embodiment is defined by a number of design parameters. Some of these are as follows:

TABLE 2

| Parameter | Value |
|---|---|
| Treatment Range | Up to 500 US Gpm/1,840 Lpm |
| Electrical Supply | 120 V, 1 Phase or 240 V, 3 Phase |
| Input Power (per lamp) | 45 W |
| Screen Size (micron) | 30 |
| Number of Screen Panels | 8 |
| Minimum Drum Submergence | 40% |
| Weight (dry) | 1,100 lbs |
| Drum Frame | 304 or 316 SS |
| Drum Shaft | 316 SS |
| Filter Enclosure | Stainless steel |
| Sectional Lid | Marine grade aluminum |
| Screen Panels | Injection molded polyester fabric |
| | embedded in polypropylene grids |
| Drum Seal | Synthetic elastomer seal wear ring |
| UV Rack | 316 SS |
| Lamp Type | Low-pressure |
| Ballast Type | Electronic, non-variable |
| Lamp Configuration | Horizontal, perpendicular flow |
| Module Configuration | 4 lamps per module |
| Dose Configuration | 30 to 200 mJ/cm2 |
| Inlet, Outlet, Solids Outlet | Flange or pipe |
| Backwash Supply | Operates at 100 psi - booster pump |
| | available |

A wide variety of other design choices are possible and feasible. For example, filter enclosure 101 may be constructed in whole or in part of materials other than stainless steel. Fiberglass might be used, as might polytetrafluoroethylene or other plastics.

Unique features of the FIG. 1 embodiment 100 are many. It has a small footprint compared to traditional disinfection packages. It provides louvered flow balancing. Easy access to filter and ultraviolet components is provided. There are multiple open-channel ultraviolet modules, and the system is highly configurable to meet water-application requirements. The net result is is an all-in-one, ready-to-use apparatus for treating process flows with particulate and microbial contaminations.

The FIG. 1 embodiment 100 has the lowest operating head of available filtration and disinfection solutions. There is packaged biosecurity, with fully integrated particle removal and disinfection. Pre-filtration optimizes ultraviolet disinfection. Plug and play design reduces engineering and installation costs. There is continuous filtering and disinfection, even during backwashing. Water consumption during backwash is minimal, and there is no downtime during exchange of ultraviolet bulbs.

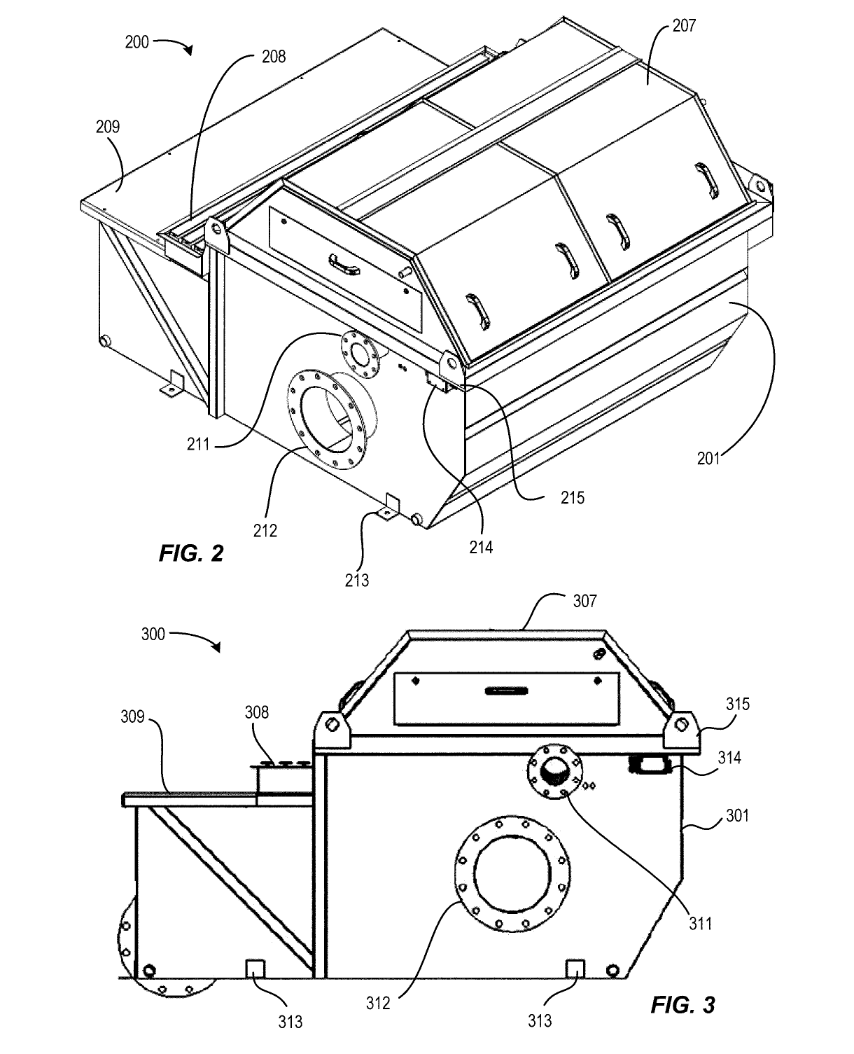

FIG. 2 depicts the FIG. 1 embodiment 100 in an unexploded format 200 from the same perspective. The components of FIG. 2 embodiment 200 correspond to the components of FIG. 1 embodiment 100.

FIG. 3 depicts the FIG. 1 embodiment 100 in an unexploded format 300 from a side perspective. The components of FIG. 3 embodiment 300 correspond to the components of FIG. 1 embodiment 100.

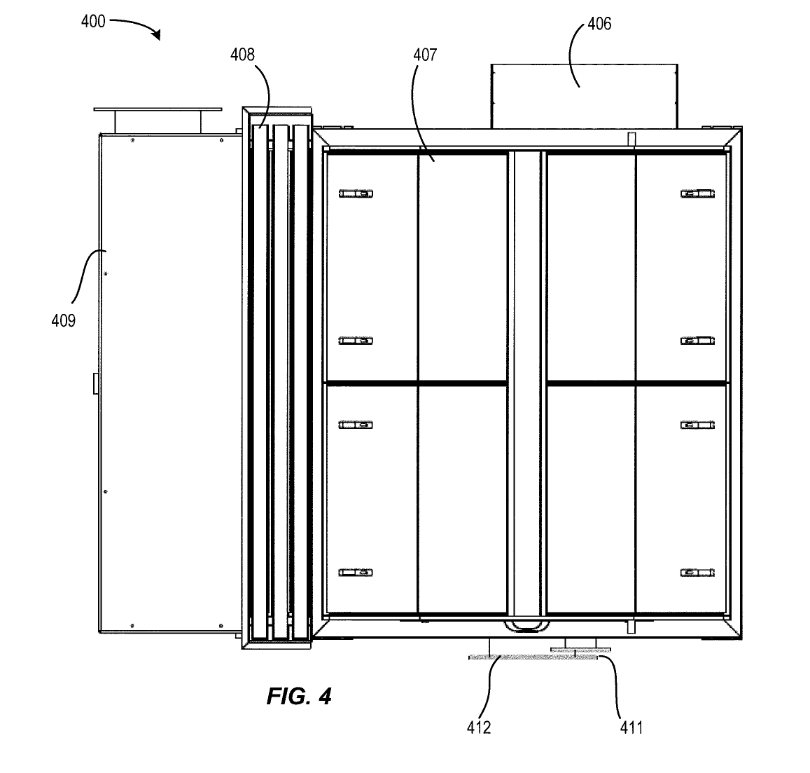

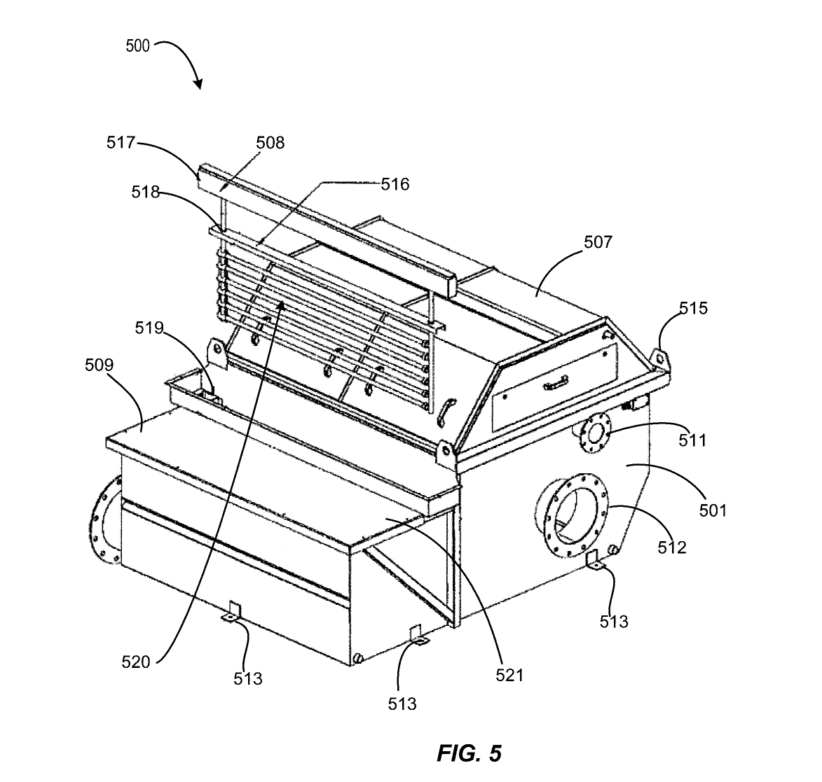

FIG. 4 depicts the FIG. 1 embodiment 100 in an unexploded format 400 from a top perspective. The components of FIG. 4 embodiment 400 correspond to the components of FIG. 1 embodiment 100.

FIG. 5 depicts the FIG. 1 embodiment 100 in an unexploded format 500 from a rear perspective. The components of FIG. 5 embodiment 500 correspond to the components of FIG. 1 embodiment 100, and details of an ultraviolet module 508 corresponding to module 108 are depicted in FIG. 5. An upper horizontal handling member 517 carries two vertical receptacle members 518, both of which are fitted with a series of lamp receptacles that receive power from an electrical connection cable affixed to member 517. Ultraviolet lamps 520 are inserted in the lamp receptacles for electrical connection and mechanical support. A horizontal light block bar 516 straddles the two receptacle members 518 to protect the user from exposure to ultraviolet light. In use, the ultraviolet module 508 is lowered into ultraviolet box 521 and covered. As noted, more than one ultraviolet module 508 may be used simultaneously, depending on the application.

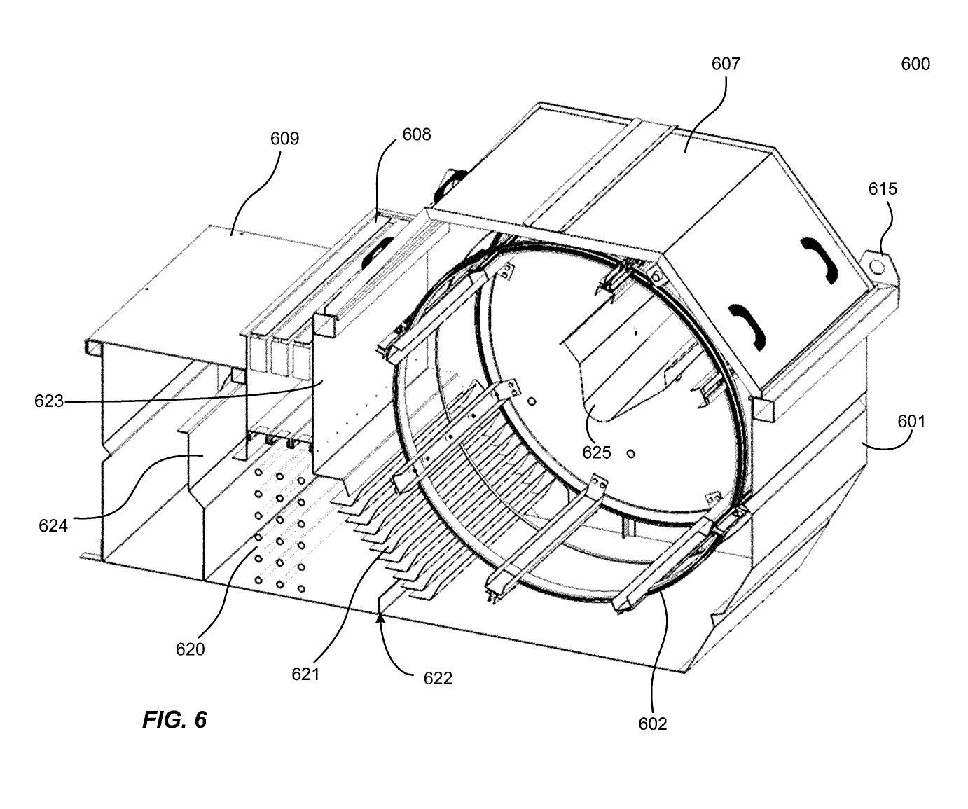

FIG. 6 depicts the FIG. 1 embodiment 100 in an unexploded format 500 from the same perspective as FIG. 2, except that the embodiment of FIG. 2 has been sectioned to reveal inner details of the apparatus. The components of FIG. 6 embodiment 600 correspond to the components of FIG. 1 embodiment 100. Filtrate flows from drum assembly 602 (shown without screens) through a multi-vaned louver 621, which directs the flow at the bulbs of three ultraviolet modules 608 made up of elongated ultraviolet bulbs 620. Baffle 622 further directs the flow of filtrate to the ultraviolet bulbs, as does baffle 624, which effectively forces water through louver 621. Vertical end baffling is provided at each end of each ultraviolet module. These end baffles force water that is moving at the outer vertical surfaces of the apparatus directly onto the ultraviolet bulbs. The combination of louver 621, baffle 622, baffle 624 and the end baffles maximize the efficiency of the process of disinfecting the water flow by assuring that as much of the filtrate as possible receives UV radiation from the ultraviolet bulbs. In addition, efficiency of irradiation is further enhanced by the turbulence created by louver 621, baffle 622, baffle 624 and the end baffles.

Of further interest in FIG. 6 is the trough 625, which receives particulates and microbes dislodged from drum assembly 602. This occurs during a cleaning cycle in which a backwash system initiates a spray of water from a spray bar located in lid assembly 607. The spray dislodges the particulates and microbes from the filter screens of drum assembly 602, which are collected in a trough 625. The clean screen panels are rotated into the water from inlet 112, rotation of drum assembly 102 stops and flow is improved, lowering the water level inside drum assembly 102. The backwash system automatically shuts down to save power. The particulates and microbes collected in trough 625 are removed from the system.

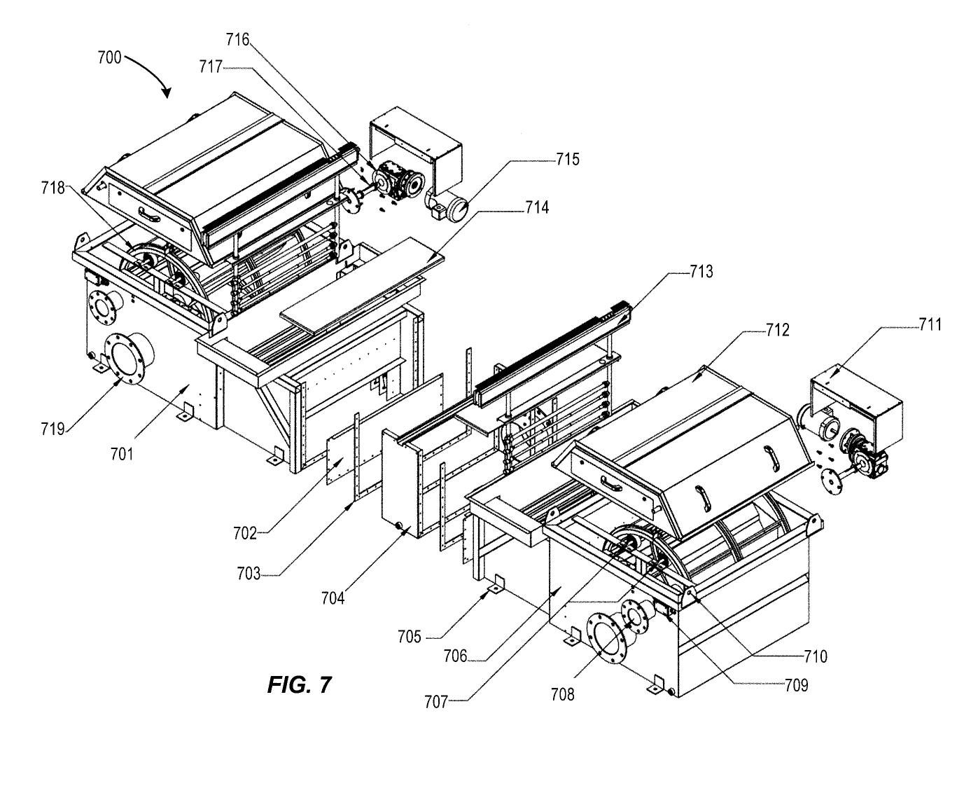

FIG. 7 depicts an exploded view of another preferred embodiment 700 of some inventions of this application, as defined in the claims that follow. Following is a list and description of operating components of this unit:

TABLE 3

| Item | Component | Description |
|---|---|---|
| 701 | Filter enclosure | Stainless steel construction |
| 702 | Weir plate | Designed to keep water level outside of |
| | | drum at correct height. |
| 703 | Gasket | Water tight seal connection between filter |
| | | and outlet box. |
| 704 | Central outlet box | Effluent accumulation chamber for both |
| | | filters, with 10″ flanged outlet. |
| 705 | Location tabs | For securing filter to mounting surface. |
| 707 | Filter enclosure, | Stainless steel construction |
| | normal rotation | |
| 707 | Support wheel | Drum support wheels with finger guards. |
| | assemblies | |
| 708 | Solids outlet | 4″ flanged outlet from sludge tray. |
| 709 | Junction box | Water tight connection point for filter float |
| | | switches. |
| 710 | Lifting lugs | Lifting points for filter installation. Use |
| | | spreader bar if necessary when lifting. |
| 711 | Motor cover | Cover for protecting drive system from the |
| | assembly | elements and to cover exposed moving |
| | | parts. |
| 712 | Lid assembly | Aluminum construction, with removable lid |
| | | panels, access door and spray bar |
| | | assembly. |
| 713 | UV module | UV module, complete with bulbs and quartz |
| | | sleeves. |
| 714 | Weir/UV chamber | Aluminum checker plate construction. |
| | lid | Cover for blocking UV light and can be |
| | | used a platform for UV module |
| | | installation/removal. |
| 715 | Motor | Electric motor for drive system |
| 717 | Gear | Reduction gear for drive system. |
| 717 | Drive shaft | Main component of drive system. |
| 718 | Drum assembly | Drum frame and associated parts. Screen |
| | | panels not shown for clarity. |
| 719 | Inlet | 8″ flanged inlet for influent water. |

Broadly speaking, the FIG. 7 embodiment 700 comprises two of the FIG. 1 embodiments 100, with one being a mirror image of the other. The operation, benefits and features of each of the two units is as described above with respect to the single FIG. 1 embodiment 100. The purpose of the FIG. 7 embodiment 701 is to effectively double the handling capacity or provide full redundancy of the FIG. 1 embodiment in as little space as possible. As shown in FIG. 7, the two units of the FIG. 7 embodiment 701 are joined by a central outlet box 704, which is an effluent accumulation chamber with a flanged outlet.

The FIG. 7 embodiment 700 is defined by a number of design parameters. Some of these are as follows:

TABLE 4

| Parameter | Value |
|---|---|
| Treatment Range | Up to 1000 US Gpm/1,840 Lpm |
| Electrical Supply | 120 V, 1 Phase |
| Input Power (per lamp) | 87.5 W |
| Screen Size (micron) | 30 |
| Number of Screen Panels | 16 |
| Minimum Drum Submergence | 40% |
| Weight (dry) | 2000 lbs |
| Drum Frame | 304 or 316 SS |
| Drum Shaft | 316 SS |
| Filter Enclosure | Stainless steel |
| Sectional Lid | Marine grade aluminum |
| Screen Panels | Injection molded polyester fabric |
| | embedded in polypropylene grids |
| Drum Seal | Synthetic elastomer seal wear ring |
| UV Rack | 316 SS |
| Lamp Type | Low-pressure |
| Ballast Type | Electronic, non-variable |
| Lamp Configuration | Horizontal, perpendicular flow |
| Module Configuration | 6 lamps per module |
| Dose Configuration | 30 to 200 mJ/cm² |
| Inlet, Outlet, Solids Outlet | Flange or pipe |
| Backwash Supply | Operates at 100 psi - booster pump |
| | available |

A wide variety of other design choices are possible and feasible. For example, filter enclosure 701 may be constructed in whole or in part of materials other than stainless steel. Fiberglass might be used, as might polytetrafluoroethylene or other plastics.

We claim as follows:

1. An apparatus for removing and disinfecting particulate matter from a process flow comprising:
a. a filtration unit comprising at least one filtration screen;
b. a disinfectant unit comprising a source of disinfecting light, and
c. a passage for filtrate from the filtration unit to the disinfectant unit.

2. The apparatus of claim 1 where the filtration unit comprises at least one static drum with one or more filtration screens on its periphery.

2. The apparatus of claim 1 where the filtration unit comprises at least one rotating drum with one or more filtration screens on its periphery.

3. The apparatus of claim 1 where the filtration unit comprises at least one filter pack comprising a first filter screen and at least one other filter screen that is different in mesh from the first filter screen

4. The apparatus of claim 1 where the passage for filtrate is fitted with a louver.

5. The apparatus of claim 4 where one or more louver vanes are aimed at the source of disinfecting light.

6. The apparatus of claim 4 where the louver creates turbulence.

7. The apparatus of claim 1 where the passage for filtrate is fitted with at least one baffle.

8. The apparatus of claim 7 where each baffle blocks flow around the source of disinfecting light.

9. The apparatus of claim 7 where each baffle creates turbulence.

10. The apparatus of claim 1 where the disinfecting light is ultraviolet light.

11. The apparatus of claim 1 where the source of disinfecting light is one or more elongated bulbs.

12. The apparatus of claim 11 where the axis of each bulb is horizontal.

13. The apparatus of claim 1 where the source of disinfecting light is a multiplicity of elongated bulbs arranged in a horizontal array.

14. The apparatus of claim 13 where the array creates turbulence.

15. The apparatus of claim 13 where the surfaces of the apparatus adjacent to the array are reflective.

16. The apparatus of claim 2 where the filtration unit comprises a level detector that is triggered when the screens of the filtration unit become loaded with particulates.

17. The apparatus of claim 16 where the filtration unit comprises a spray bar that washes particulates from the screens.

18. An apparatus for removing and disinfecting particulate matter from a process flow comprising:
a. a first filtration unit comprising filtration screens;
b. a first disinfectant unit comprising a source of disinfecting light;
c. a first passage for filtrate from the first filtration unit to the first disinfectant unit;
d. a second filtration unit comprising filtration screens;
e. a second disinfectant unit comprising a source of disinfecting light;
f. a second passage for filtrate from the second filtration unit to the second disinfectant unit; and
g. a central outlet box joining the first disinfectant unit with the second disinfectant unit.

19. A process for removing and disinfecting particulate matter from a process flow comprising the following steps:
a. filtering the process flow to remove a majority of the particulate matter;
b. directing the filtrate to a source of disinfecting light while creating turbulence in the filtrate; and
c. disinfecting the filtrate.
